(19) United States
(12) Patent Application Publication
(10) Pub. No.: US 2026/0004717 A1
(43) Pub. Date: Jan. 1, 2026

(54) PIXEL, DISPLAY DEVICE INCLUDING THE SAME, AND ELECTRONIC APPARATUS INCLUDING THE SAME

(71) Applicant: Samsung Display Co., LTD., Yongin-si (KR)

(72) Inventor: HEECHUL LEE, Yongin-si (KR)

(21) Appl. No.: 19/169,332

(22) Filed: Apr. 3, 2025

(30) Foreign Application Priority Data
Jun. 26, 2024 (KR) 10-2024-0083441
Jul. 18, 2024 (KR) 10-2024-0095264

(51) Int. Cl. G09G 3/32

(52) U.S. Cl. CPC G09G 3/32; G09G 2300/0819; G09G 2320/0233; G09G 2320/0257; G09G 2330/022

(57) ABSTRACT

A pixel includes a light-emitting element which emits light based on a driving current and includes a first electrode and a second electrode which receives a low power voltage, a driving transistor which generates the driving current and includes a gate connected to a first node, a first terminal connected to a second node, a second terminal connected to a third node, and a body, a body capacitor which includes a first terminal connected to the body of the driving transistor and a second terminal, and a body transistor which includes a gate which receives a body gate signal, a first terminal connected to the second terminal of the body capacitor, and a second terminal connected to the third node.

This application claims priority to Korean Patent Application No. 10-2024-0083441, filed on Jun. 26, 2024, and Korean Patent Application No. 10-2024-0095264, filed on Jul. 18, 2024, and all the benefits accruing therefrom under 35 U.S.C. § 119, the content of which in their entirety is herein incorporated by reference.

### BACKGROUND

### 1. Field

Embodiments relate to a display device. More particularly, embodiments relate to a pixel including a plurality of transistors, a display device including the pixel, and an electronic apparatus including the pixel.

### 2. Description of the Related Art

A display device may include a display panel and a panel driver. The display panel may include a plurality of pixels. The panel driver may provide data voltages, gate signals, etc., to the pixels.

The pixel may include a light-emitting element and a plurality of transistors. The transistors may generate a driving current based on the data voltage, the gate signal, etc. The light-emitting element may emit light with a luminance corresponding to the driving current.

When charges are accumulated on a substrate of the display device due to ultraviolet light or the like applied from the outside of the display device, a negative bias may be applied to a body of the transistor. Accordingly, a body effect in which a threshold voltage of the transistor shifts may occur.

### SUMMARY

Embodiments provide a pixel which compensates a body voltage of a transistor, a display device including the pixel, and an electronic apparatus including the pixel.

A pixel in an embodiment of the disclosure includes a light-emitting element which emits light based on a driving current and includes a first electrode and a second electrode which receives a low power voltage having a relatively low power voltage level, a driving transistor which generates the driving current and includes a gate connected to a first node, a first terminal connected to a second node, a second terminal connected to a third node, and a body, a body capacitor which includes a first terminal connected to the body of the driving transistor and a second terminal, and a body transistor which includes a gate which receives a body gate signal, a first terminal connected to the second terminal of the body capacitor, and a second terminal connected to the third node.

In an embodiment, the pixel may further include a writing transistor which includes a gate which receives a writing gate signal, a first terminal which receives a data voltage, and a second terminal connected to the second node, a compensation transistor which includes a gate which receives a compensation gate signal, a first terminal connected to the third node, and a second terminal connected to the first node, and an initialization transistor which includes a gate which receives an initialization gate signal, a first terminal which receives an initialization voltage, and a second terminal connected to the first node.

In an embodiment, the body gate signal may have an activation level in an initialization period in which the initialization gate signal has an activation level.

In an embodiment, a body voltage of the body of the driving transistor may be applied to the third node in the initialization period.

In an embodiment, the body gate signal may have a plurality of pulses in which an activation level and a deactivation level alternate in an initialization period in which the initialization gate signal has an activation level.

In an embodiment, the body gate signal may have a deactivation level in a writing-compensation period in which each of the writing gate signal and the compensation gate signal has an activation level.

In an embodiment, a value obtained by subtracting a threshold voltage of the driving transistor and a body voltage of the body of the driving transistor from the data voltage may be applied to the first node in the writing-compensation period.

In an embodiment, the pixel may further include a first emission transistor which includes a gate which receives an emission signal, a first terminal which receives a high power voltage having a relatively low power voltage level, and a second terminal connected to the second node, and a second emission transistor which includes a gate which receives the emission signal, a first terminal connected to the third node, and a second terminal connected to the first electrode of the light-emitting element.

In an embodiment, the body gate signal may have a deactivation level in an emission period in which the emission signal has an activation level.

In an embodiment, the pixel may further include a bypass transistor which includes a gate which receives a bypass gate signal, a first terminal which receives the initialization voltage, and a second terminal connected to the first electrode of the light-emitting element.

In an embodiment, a variable voltage may be applied to the body of the driving transistor.

In an embodiment, the variable voltage may have a voltage level equal to the relatively low power voltage level of the low power voltage in an initialization period in which the initialization gate signal has an activation level, and may have a voltage level equal to the relatively high power voltage level of the high power voltage in an emission period in which the emission signal has an activation level.

A display device in an embodiment of the disclosure includes a display panel which includes a pixel, and a panel driver which provides a data voltage, gate signals, and an emission signal to the pixel. The pixel includes a light-emitting element which emits light based on a driving current and includes a first electrode and a second electrode which receives a low power voltage having a relatively low power voltage level, a driving transistor which generates the driving current and includes a gate connected to a first node, a first terminal connected to a second node, a second terminal connected to a third node, and a body, a body capacitor which includes a first terminal connected to the body of the driving transistor and a second terminal, and a body transistor which includes a gate which receives a body gate signal of the gate signals, a first terminal connected to the second terminal of the body capacitor, and a second terminal connected to the third node.

In an embodiment, the pixel may further include a writing transistor which includes a gate which receives a writing gate signal of the gate signals, a first terminal which receives the data voltage, and a second terminal connected to the second node, a compensation transistor which includes a gate which receives a compensation gate signal of the gate signals, a first terminal connected to the third node, and a second terminal connected to the first node, and an initialization transistor which includes a gate which receives an initialization gate signal of the gate signals, a first terminal which receives an initialization voltage, and a second terminal connected to the first node.

In an embodiment, the body gate signal may have an activation level in an initialization period in which the initialization gate signal has an activation level.

In an embodiment, the body gate signal may have a deactivation level in a writing-compensation period in which each of the writing gate signal and the compensation gate signal has an activation level.

In an embodiment, the pixel may further include a first emission transistor which includes a gate which receives the emission signal, a first terminal which receives a high power voltage having a relatively low power voltage level, and a second terminal connected to the second node, and a second emission transistor which includes a gate which receives the emission signal, a first terminal connected to the third node, and a second terminal connected to the first electrode of the light-emitting element.

In an embodiment, the body gate signal may have a deactivation level in an emission period in which the emission signal has an activation level.

In an embodiment, the pixel may further include a bypass transistor which includes a gate which receives a bypass gate signal of the gate signals, a first terminal which receives the initialization voltage, and a second terminal connected to the first electrode of the light-emitting element.

An electronic apparatus in embodiments includes a display panel which includes a pixel, a panel driver which provides a data voltage, gate signals, and an emission signal to the pixel, and a processor which provides image data to the panel driver. The pixel includes a light-emitting element which includes a first electrode and a second electrode which receives a low power voltage having a relatively low power voltage level, and emits light based on a driving current, a driving transistor which generates the driving current and includes a gate connected to a first node, a first terminal connected to a second node, a second terminal connected to a third node, and a body, a body capacitor which includes a first terminal connected to the body of the driving transistor and a second terminal, and a body transistor which includes a gate which receives a body gate signal of the gate signals, a first terminal connected to the second terminal of the body capacitor, and a second terminal connected to the third node.

In the pixel, the display device including the pixel, and the electronic apparatus including the pixel in the embodiments, the pixel includes the body capacitor and the body transistor connected between the second terminal and the body of the driving transistor, so that the body voltage of the driving transistor may be compensated. Accordingly, a luminance deviation of light emitted from the pixels may decrease, and image quality of the display device may be improved.

### BRIEF DESCRIPTION OF THE DRAWINGS

Illustrative, non-limiting embodiments will be more clearly understood from the following detailed description taken in conjunction with the accompanying drawings.

FIG. 1 is a block diagram showing an embodiment of a display device.

FIG. 2 is a circuit diagram showing an embodiment of a pixel of FIG. 1.

FIG. 3 is a waveform diagram showing an embodiment of gate signals and an emission signal of FIG. 2.

FIG. 4 is a view for describing an embodiment of an operation of the pixel of FIG. 2 in an initialization period.

FIG. 5 is a view for describing an operation of the pixel of FIG. 2 in a writing-compensation period.

FIG. 6 is a view for describing an operation of the pixel of FIG. 2 in an emission period.

FIG. 7 is a waveform diagram showing an embodiment of gate signals and an emission signal of FIG. 2.

FIG. 8 is a circuit diagram showing an embodiment of a pixel.

FIG. 9 is a waveform diagram showing a variable voltage, gate signals, and an emission signal of FIG. 8.

FIG. 10 is a circuit diagram showing an embodiment of a pixel.

FIG. 11 is a block diagram showing an embodiment of an electronic apparatus.

FIG. 12 is a view showing an embodiment in which the electronic apparatus of FIG. 11 is implemented as a smartphone.

### DETAILED DESCRIPTION

Hereinafter, a pixel, a display device, and an electronic apparatus in embodiments of the disclosure will be described in more detail with reference to the accompanying drawings. The same or similar reference numerals will be used for the same elements in the accompanying drawings.

It will be understood that when an element is referred to as being “on” another element, it may be directly on the other element or intervening elements may be present therebetween. In contrast, when an element is referred to as being “directly on” another element, there are no intervening elements present. It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” may therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” may, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” may mean within one or more standard deviations, or within +30%, 20%, 10%, 5% of the stated value, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

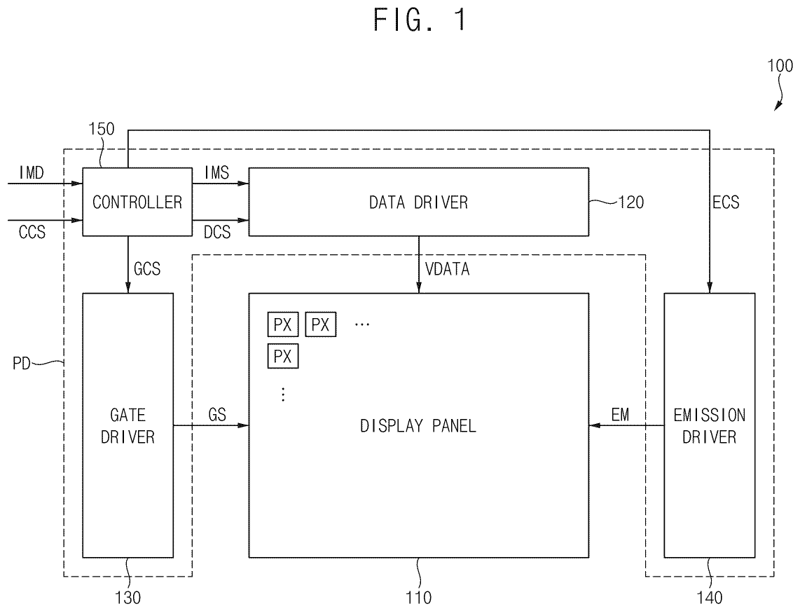

FIG. 1 is a block diagram showing an embodiment of a display device 100.

Referring to FIG. 1, the display device 100 may include a display panel 110 and a panel driver PD.

The display panel 110 may include a plurality of pixels PX. Each of the pixels PX may emit light based on a data voltage VDATA, gate signals GS, and an emission signal EM.

The panel driver PD may provide the data voltage VDATA, the gate signals GS, and the emission signal EM to each of the pixels PX. The panel driver PD may include a data driver 120, a gate driver 130, an emission driver 140, and a controller 150.

The data driver 120 may provide the data voltages VDATA to the pixels PX. The data driver 120 may generate the data voltages VDATA based on an image signal IMS and a data control signal DCS. The image signal IMS may include grayscale values corresponding to the pixels PX. The data control signal DCS may include a load signal, a data clock signal, etc.

The gate driver 130 may provide the gate signals GS to the pixels PX. The gate driver 130 may generate the gate signals GS based on a gate control signal GCS. The gate control signal GCS may include a gate start signal, a gate clock signal, etc.

The emission driver 140 may provide the emission signals EM to the pixels PX. The emission driver 140 may generate the emission signals EM based on an emission control signal ECS. The emission control signal ECS may include an emission start signal, an emission clock signal, etc.

The controller 150 may control an operation of the data driver 120, an operation of the gate driver 130, and an operation of the emission driver 140. The controller 150 may provide the image signal IMS and the data control signal DCS to the data driver 120, may provide the gate control signal GCS to the gate driver 130, and may provide the emission control signal ECS to the emission driver 140. The controller 150 may generate the image signal IMS based on image data IMD, and may generate the data control signal DCS, the gate control signal GCS, and the emission control signal ECS based on a controller control signal CCS. The image data IMD may include grayscale values corresponding to the pixels PX. The controller control signal CCS may include a data enable signal, a vertical synchronization signal, a horizontal synchronization signal, a master clock signal, etc.

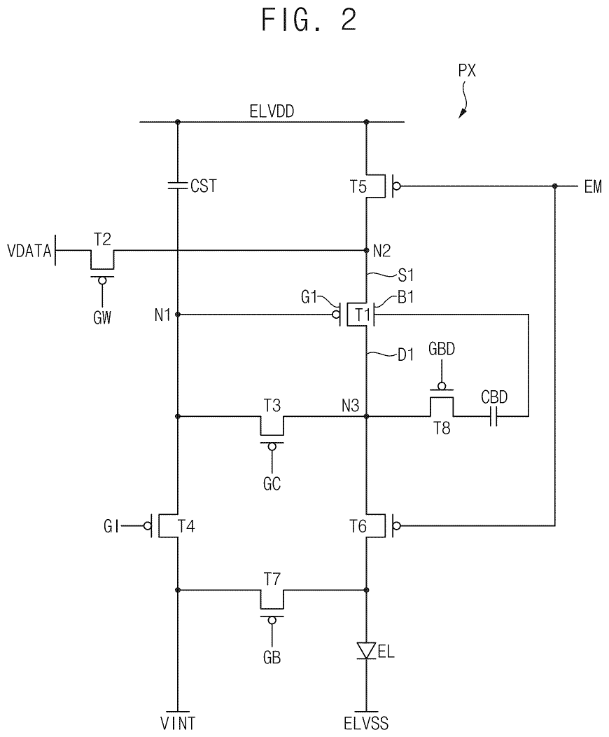

FIG. 2 is a circuit diagram showing the pixel PX of FIG. 1.

Referring to FIGS. 1 and 2, the pixel PX may receive the data voltage VDATA, a writing gate signal GW, a compensation gate signal GC, an initialization gate signal GI, a bypass gate signal GB, a body gate signal GBD, the emission signal EM, an initialization voltage VINT, a high power voltage ELVDD having a relatively high power voltage level, and a low power voltage ELVSS having a relatively low power voltage level. The gate signals GS may include the writing gate signal GW, the compensation gate signal GC, the initialization gate signal GI, the bypass gate signal GB, and the body gate signal GBD. In an embodiment, a voltage level of the high power voltage ELVDD may be higher than a voltage level of the low power voltage ELVSS.

The pixel PX may include a light-emitting element EL, a driving transistor (or a first transistor) T1, a writing transistor (or a second transistor) T2, a compensation transistor (or a third transistor) T3, an initialization transistor (or a fourth transistor) T4, a first emission transistor (or a fifth transistor) T5, a second emission transistor (or a sixth transistor) T6, a bypass transistor (or a seventh transistor) T7, a storage capacitor CST, a body capacitor CBD, and a body transistor (or an eighth transistor) T8.

The light-emitting element EL may emit light based on a driving current. The light-emitting element EL may emit light with a luminance corresponding to the driving current. The light-emitting element EL may include a first electrode (e.g., anode) and a second electrode (e.g., cathode) that receives the low power voltage ELVSS.

In an embodiment, the light-emitting element EL may be an organic light-emitting diode. In an embodiment, the light-emitting element EL may be an inorganic light-emitting diode, a quantum dot light-emitting diode, a micro light-emitting diode, etc.

The driving transistor T1 may generate the driving current. The driving transistor T1 may include a gate G1 connected to a first node N1, a first terminal (e.g., a source) S1 connected to a second node N2, a second terminal (e.g., a drain) D1 connected to a third node N3, and a body B1. In an embodiment, the driving transistor T1 may be a P-type transistor. In an embodiment, the driving transistor T1 may be a polycrystalline silicon transistor.

The writing transistor T2 may transmit the data voltage VDATA to the second node N2 in response to the writing gate signal GW. The writing transistor T2 may include a gate that receives the writing gate signal GW, a first terminal (e.g., a source) that receives the data voltage VDATA, and a second terminal (e.g., a drain) connected to the second node N2. In an embodiment, the writing transistor T2 may be a P-type transistor. In an embodiment, the writing transistor T2 may be a polycrystalline silicon transistor.

The compensation transistor T3 may connect the third node N3 to the first node N1 in response to the compensation gate signal GC. The compensation transistor T3 may include a gate that receives the compensation gate signal GC, a first terminal (e.g., a source) connected to the third node N3, and a second terminal (e.g., a drain) connected to the first node N1. In an embodiment, the compensation transistor T3 may be a P-type transistor. In an embodiment, the compensation transistor T3 may be a polycrystalline silicon transistor.

The initialization transistor T4 may transmit the initialization voltage VINT to the first node N1 in response to the initialization gate signal GI. The initialization transistor T4 may include a gate that receives the initialization gate signal GI, a first terminal (e.g., a source) that receives the initialization voltage VINT, and a second terminal (e.g., a drain) connected to the first node N1. In an embodiment, the initialization transistor T4 may be a P-type transistor. In an embodiment, the initialization transistor T4 may be a polycrystalline silicon transistor.

The first emission transistor T5 may transmit the high power voltage ELVDD to the second node N2 in response to the emission signal EM. The first emission transistor T5 may include a gate that receives the emission signal EM, a first terminal (e.g., a source) that receives the high power voltage ELVDD, and a second terminal (e.g., a drain) connected to the second node N2. In an embodiment, the first emission transistor T5 may be a P-type transistor. In an embodiment, the first emission transistor T5 may be a polycrystalline silicon transistor.

The second emission transistor T6 may connect the third node N3 to the first electrode of the light-emitting element EL in response to the emission signal EM. The second emission transistor T6 may include a gate that receives the emission signal EM, a first terminal (e.g., a source) connected to the third node N3, and a second terminal (e.g., a drain) connected to the first electrode of the light-emitting element EL. In an embodiment, the second emission transistor T6 may be a P-type transistor. In an embodiment, the second emission transistor T6 may be a polycrystalline silicon transistor.

The bypass transistor T7 may transmit the initialization voltage VINT to the first electrode of the light-emitting element EL in response to the bypass gate signal GB. The bypass transistor T7 may include a gate that receives the bypass gate signal GB, a first terminal (e.g., a source) that receives the initialization voltage VINT, and a second terminal (e.g., a drain) connected to the first electrode of the light-emitting element EL. In an embodiment, the bypass transistor T7 may be a P-type transistor. In an embodiment, the bypass transistor T7 may be a polycrystalline silicon transistor.

The storage capacitor CST may store a voltage of the first node N1. The storage capacitor CST may include a first terminal connected to the first node N1 and a second terminal that receives the high power voltage ELVDD.

The body capacitor CBD may be connected to the body B1 of the driving transistor T1. The body capacitor CBD may include a first terminal connected to the body B1 of the driving transistor T1 and a second terminal.

The body transistor T8 may transmit a body voltage of the body B1 of the driving transistor T1 to the third node N3 in response to the body gate signal GBD. The body transistor T8 may include a gate that receives the body gate signal GBD, a first terminal (e.g., a source) connected to the second terminal of the body capacitor CBD, and a second terminal (e.g., a drain) connected to the third node N3. In an embodiment, the body transistor T8 may be a P-type transistor. In an embodiment, the body transistor T8 may be a polycrystalline silicon transistor.

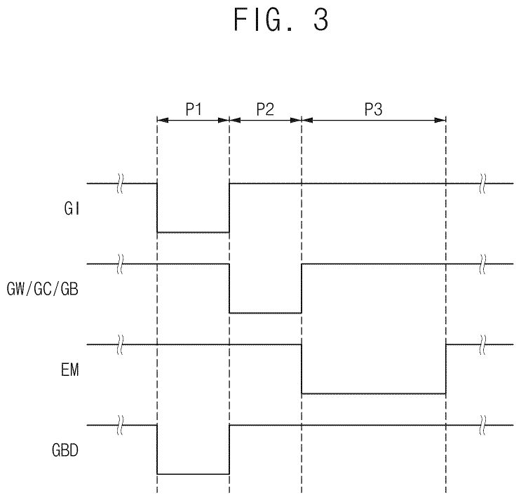

FIG. 3 is a waveform diagram showing an embodiment of the gate signals GI, GW, GC, GB, and GBD and the emission signal EM of FIG. 2.

Referring to FIGS. 2 and 3, the initialization gate signal GI may have an activation level (e.g., a logic low level) in an initialization period P1 and a deactivation level (e.g., a logic high level) in a writing-compensation period P2 and an emission period P3.

Each of the writing gate signal GW, the compensation gate signal GC, and the bypass gate signal GB may have an activation level (e.g., a logic low level) in the writing-compensation period P2 and a deactivation level (e.g., a logic high level) in the initialization period P1 and the emission period P3.

Although FIG. 3 illustrates an embodiment in which the writing gate signal GW, the compensation gate signal GC, and the bypass gate signal GB are substantially the same, the disclosure is not limited thereto. In an embodiment, the compensation gate signal GC may be a signal in which the initialization gate signal GI is shifted by a predetermined time duration. In an embodiment, the bypass gate signal GB may be a signal in which the writing gate signal GW is shifted by a predetermined time duration.

The emission signal EM may have an activation level (e.g., a logic low level) in the emission period P3 and a deactivation level (e.g., a logic high level) in the initialization period P1 and the writing-compensation period P2.

The body gate signal GBD may have an activation level (e.g., a logic low level) in the initialization period P1 and a deactivation level (e.g., a logic high level) in the writing-compensation period P2 and the emission period P3.

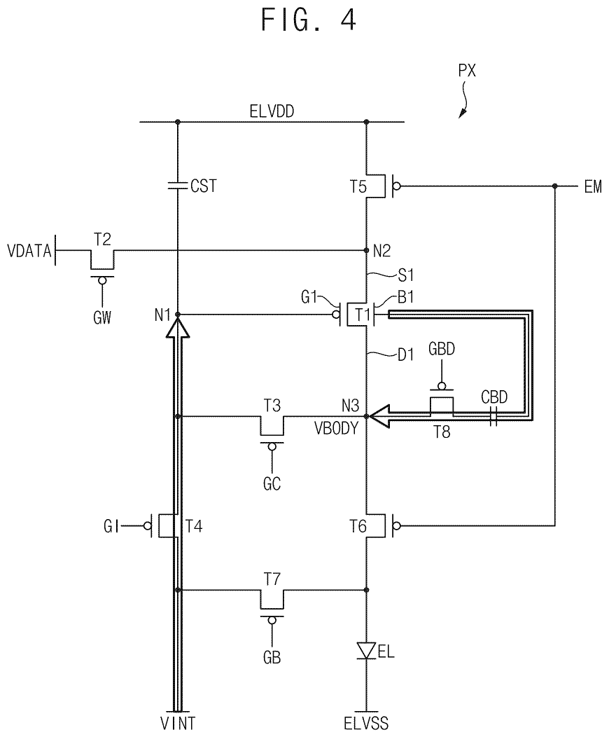

FIG. 4 is a view for describing an operation of the pixel PX of FIG. 2 in the initialization period P1.

Referring to FIGS. 3 and 4, in the initialization period P1, the initialization transistor T4 may be turned on in response to the initialization gate signal GI having the activation level, and the initialization voltage VINT may be applied to the first node N1 through the initialization transistor T4. Accordingly, the driving transistor T1 may be initialized.

In the initialization period P1, the body transistor T8 may be turned on in response to the body gate signal GBD having the activation level, and the body voltage VBODY of the body B1 of the driving transistor T1 may be applied to the third node N3 through the body capacitor CBD and the body transistor T8.

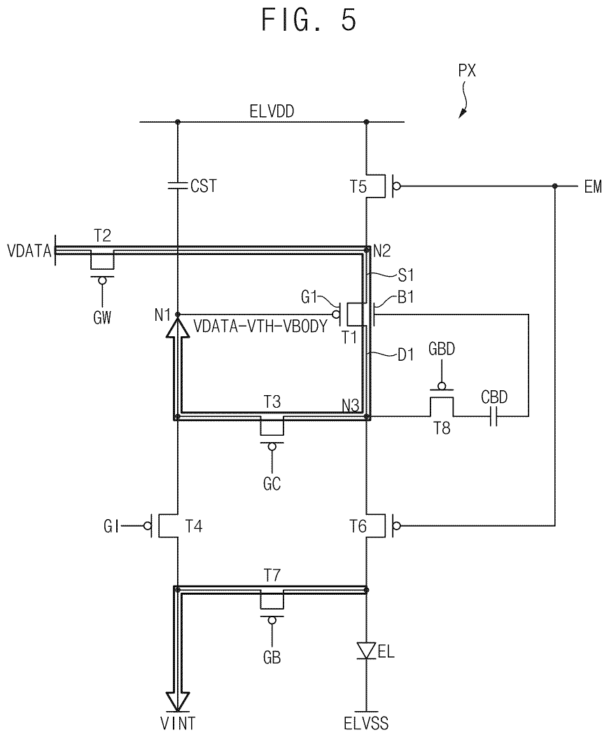

FIG. 5 is a view for describing an operation of the pixel PX of FIG. 2 in the writing-compensation period P2.

Referring to FIGS. 3 and 5, in the writing-compensation period P2, the writing transistor T2 may be turned on in response to the writing gate signal GW having the activation level, the compensation transistor T3 may be turned on in response to the compensation gate signal GC having the activation level, and a value VDATA-VTH-VBODY obtained by subtracting a threshold voltage VTH of the driving transistor T1 and the body voltage VBODY of the driving transistor T1 from the data voltage VDATA may be applied to the first node N1 through the writing transistor T2, the driving transistor T1, and the compensation transistor T3.

In the writing-compensation period P2, the bypass transistor T7 may be turned on in response to the bypass gate signal GB having the activation level, and the initialization voltage VINT may be applied to the first electrode of the light-emitting element EL through the bypass transistor T7. Accordingly, charges stored in the first electrode of the light-emitting element EL may be discharged through the bypass transistor T7, and the light-emitting element EL may be initialized.

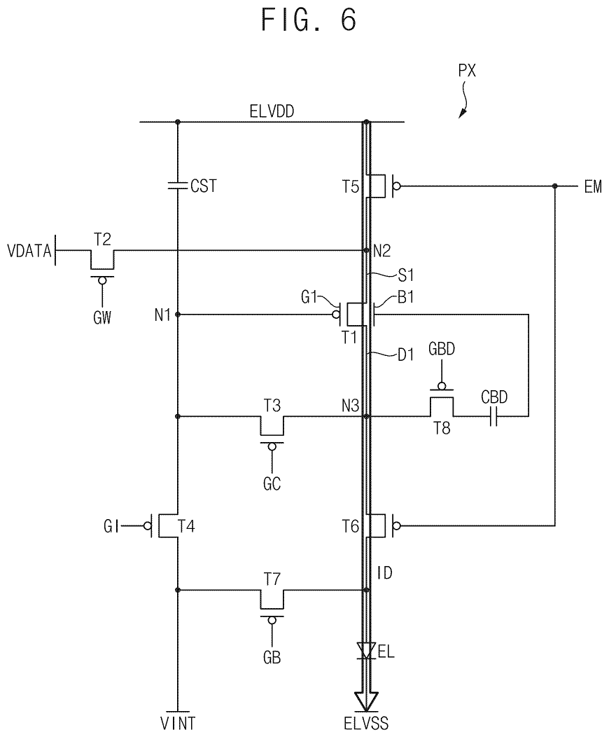

FIG. 6 is a view for describing an operation of the pixel PX of FIG. 2 in the emission period P3.

Referring to FIGS. 3 and 6, in the emission period P3, the first emission transistor T5 and the second emission transistor T6 may be turned on in response to the emission signal EM having the activation level, the driving transistor T1 may generate the driving current ID, and the light-emitting element EL may emit light with a luminance corresponding to the driving current ID. In the emission period P3, a voltage VS of the first terminal S1 of the driving transistor T1 may be calculated by Equation 1, a voltage VG of the gate G1 of the driving transistor T1 may be calculated by Equation 2, and the driving current ID may be calculated by Equation 3.

$$VS = ELVDD \qquad [ Equation 1 ]$$

$$VG = VDATA - VTH - VBODY \qquad [ Equation 2 ]$$

$$ID = \text{} K \times {( VSG - VTH - VBODY )}^{2} = K \times {( ELVDD - VDATA )}^{2} \qquad [ Equation 3 ]$$

In Equation 3, K is a proportional constant, and VSG is a value obtained by subtracting the voltage VG of the gate G1 of the driving transistor T1 from the voltage VS of the first terminal S1 of the driving transistor T1. According to Equation 3, the driving current ID may be determined by the data voltage VDATA regardless of the threshold voltage VTH of the driving transistor T1 and the body voltage VBODY of the driving transistor T1.

When charges are accumulated on a substrate of the display device 100 due to ultraviolet rays or the like applied from the outside of the display device 100, a negative bias may be applied to the body B1 of the driving transistor T1, so that a body effect in which the threshold voltage of the driving transistor T1 shifts. When the body effect occurs in the driving transistor T1, a luminance deviation of light emitted from the pixels PX may increase, and image quality of the display device 100 may deteriorate.

In the illustrated embodiment, since the pixel PX includes the body capacitor CBD and the body transistor T8 connected between the second terminal D1 and the body B1 of the driving transistor T1, the body voltage VBODY of the driving transistor T1 may be compensated. Accordingly, the luminance deviation of light emitted from the pixels PX may decrease, and the image quality of the display device 100 may be improved.

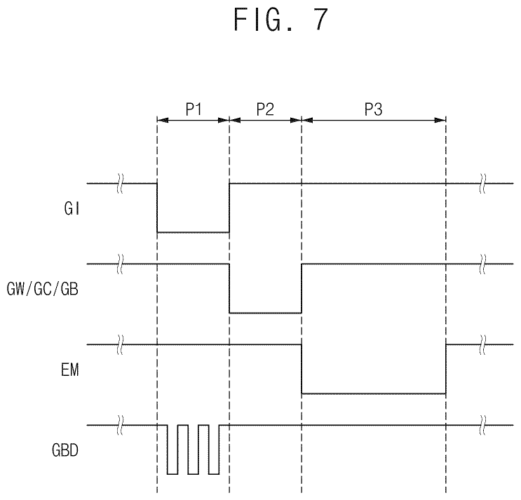

FIG. 7 is a waveform diagram showing an embodiment of the gate signals GI, GW, GC, GB, and GBD and the emission signal EM of FIG. 2.

The gate signals GI, GW, GC, GB, and GBD and the emission signal EM described with reference to FIG. 7 may be substantially the same as or similar to the gate signals GI, GW, GC, GB, and GBD and the emission signal EM described with reference to FIG. 3, except for the body gate signal GBD.

Referring to FIGS. 2 and 7, the body gate signal GBD may have a plurality of pulses in which an activation level (e.g., a logic low level) and a deactivation level (e.g., a logic high level) alternate in the initialization period P1, and may have the deactivation level in the writing-compensation period P2 and the emission period P3.

In the initialization period P1, the body transistor T8 may be turned on in response to the pulses of the body gate signal GBD, and the body voltage VBODY of the body B1 of the driving transistor T1 may be applied to the third node N3 through the body capacitor CBD and the body transistor T8.

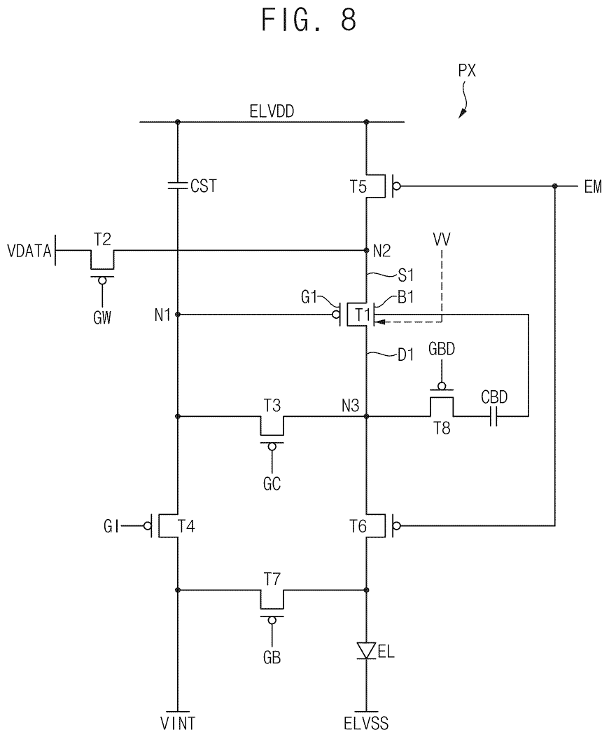

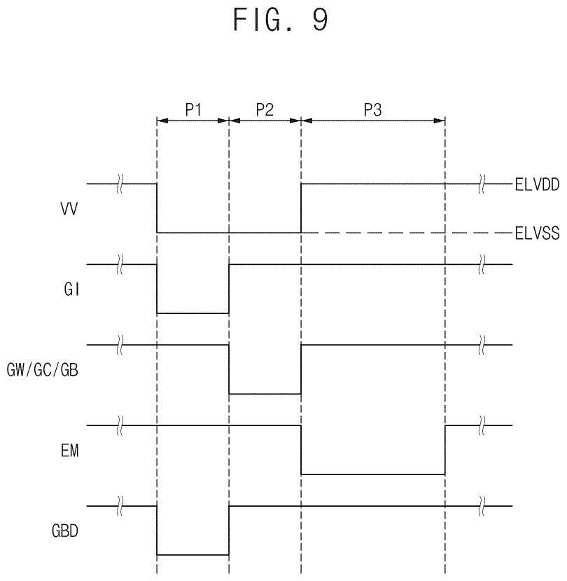

FIG. 8 is a circuit diagram showing an embodiment of a pixel PX. FIG. 9 is a waveform diagram showing a variable voltage VV, gate signals GI, GW, GC, GB, and GBD, and an emission signal EM of FIG. 8.

The pixel PX described with reference to FIG. 8 may be substantially the same as or similar to the pixel PX described with reference to FIG. 2 except for the variable voltage VV. The gate signals GI, GW, GC, GB, and GBD and the emission signal EM described with reference to FIG. 9 may be substantially the same as or similar to the gate signals GI, GW, GC, GB, and GBD and the emission signal EM described with reference to FIG. 3.

Referring to FIGS. 8 and 9, the variable voltage VV may be applied to the body B1 of the driving transistor T1. In an embodiment, the variable voltage VV may have a voltage level equal to the relatively low power voltage level of the low power voltage ELVSS in the initialization period P1, and may have a voltage level equal to the relatively high power voltage level of the high power voltage ELVDD in the emission period P3. In an embodiment, the voltage level of the variable voltage VV may transition to the voltage level of the low power voltage ELVSS at the start of the initialization period P1, and may transition to the voltage level of the high power voltage ELVDD at the start of the emission period P3, for example.

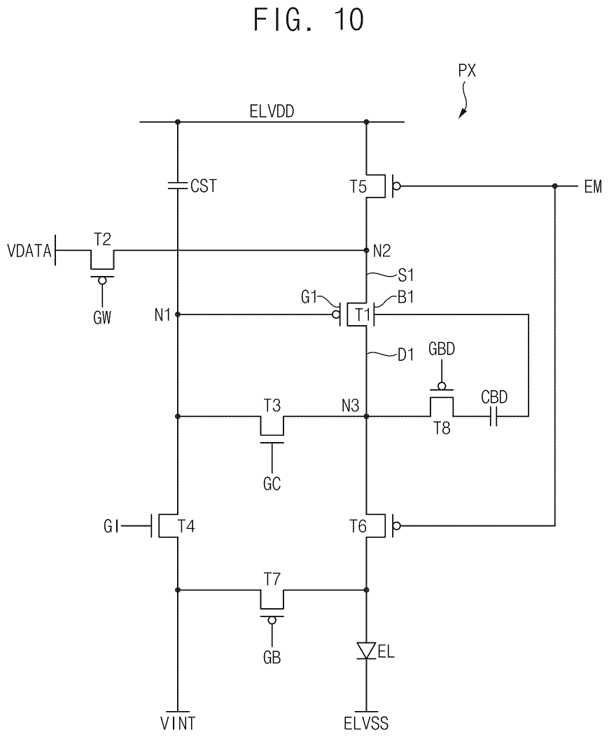

FIG. 10 is a circuit diagram showing an embodiment of a pixel PX.

The pixel PX described with reference to FIG. 10 may be substantially the same as or similar to the pixel PX described with reference to FIG. 2, except for the compensation transistor T3 and the initialization transistor T4.

Referring to FIG. 10, the compensation transistor T3 may connect the third node N3 to the first node N1 in response to the compensation gate signal GC. The compensation transistor T3 may include a gate that receives the compensation gate signal GC, a first terminal (e.g., a drain) connected to the third node N3, and a second terminal (e.g., a source) connected to the first node N1. In an embodiment, the compensation transistor T3 may be an N-type transistor. In an embodiment, the compensation transistor T3 may be an oxide semiconductor transistor.

The initialization transistor T4 may transmit the initialization voltage VINT to the first node N1 in response to the initialization gate signal GI. The initialization transistor T4 may include a gate that receives the initialization gate signal GI, a first terminal (e.g., a drain) that receives the initialization voltage VINT, and a second terminal (e.g., a source) connected to the first node N1. In an embodiment, the initialization transistor T4 may be an N-type transistor. In an embodiment, the initialization transistor T4 may be an oxide semiconductor transistor.

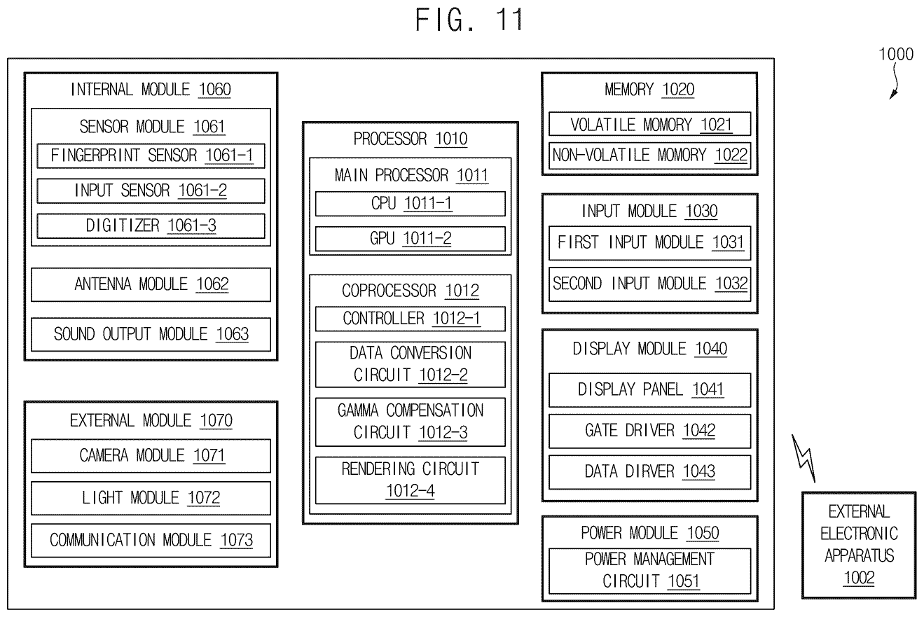

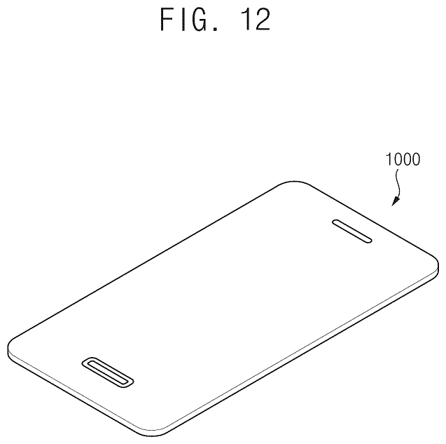

FIG. 11 is a block diagram showing an embodiment of an electronic apparatus 1000. FIG. 12 is a view showing an embodiment in which the electronic apparatus 1000 of FIG. 11 is implemented as a smartphone.

Referring to FIGS. 11 and 12, the electronic apparatus 1000 may output various information through a display module 1040 within operating system. When a processor 1010 executes an application stored in a memory 1020, the display module 1040 may provide application information to a user through a display panel 1041.

In an embodiment, as illustrated in FIG. 12, the electronic apparatus 1000 may be implemented as a smartphone. However, the disclosure is not limited thereto, and in another embodiment, the electronic apparatus 1000 may be implemented as a television, a computer monitor, a video phone, a smart pad, a smart watch, a tablet personal computer (“PC”), a vehicle navigation, a laptop, a head mounted display device, etc.

The processor 1010 may obtain an external input through an input module 1030 or a sensor module 1061, and may execute an application corresponding to the external input. In an embodiment, when the user selects a camera icon displayed on the display panel 1041, the processor 1010 may obtain a user input through an input sensor 1061-2, and may activate a camera module 1071, for example. The processor 1010 may transmit image data corresponding to a captured image acquired through the camera module 1071 to the display module 1040. The display module 1040 may display an image corresponding to the captured image through the display panel 1041. Some of components of the electronic apparatus 1000 may be integrated and provided as one component, or one component may be provided separately into two or more components.

The electronic apparatus 1000 may communicate with an external electronic apparatus 1002 through a network (e.g., a short-range wireless communication network or a long-range wireless communication network). In an embodiment, the electronic apparatus 1000 may include the processor 1010, the memory 1020, the input module 1030, the display module 1040, a power module 1050, an internal module 1060, and an external module 1070. In an embodiment, the electronic apparatus 1000 may omit at least one of the above-described components, or one or more other components may be added. In an embodiment, some of the above-described components (e.g., a sensor module 1061, an antenna module 1062, or a sound output module 1063) may be integrated into another component (e.g., the display module 1040).

The processor 1010 may execute software to control at least one other component (e.g., hardware or software component) of the electronic apparatus 1000 connected to the processor 1010, and may perform various data processing or calculation. In an embodiment, as at least part of data processing or calculation, the processor 1010 may store commands or data received from another component (e.g., the input module 1030, the sensor module 1061, or a communication module 1073) in a volatile memory 1021, may process the commands or data stored in the volatile memory 1021, and may store resultant data in a non-volatile memory 1022.

The processor 1010 may include a main processor 1011 and a coprocessor 1012. The main processor 1011 may include one or more of a central processing unit (“CPU”) 1011-1 or an application processor (“AP”). The main processor 1011 may further include one or more of a graphics processing unit (“GPU”) 1011-2, a communication processor (“CP”), and an image signal processor (“ISP”). At least two of the above-described processing unit and processor may be implemented as an integrated component (e.g., a single chip), or each may be implemented as an independent component (e.g., a plurality of chips).

The coprocessor 1012 may include a controller 1012-1. The controller 1012-1 may include an interface conversion circuit and a timing control circuit. The controller 1012-1 may receive an image signal from the main processor 1011, may convert data format of the image signal to suit the interface specifications with the display module 1040, and may output image data. The controller 1012-1 may output various control signals desired for driving the display module 1040.

The coprocessor 1012 may further include a data conversion circuit 1012-2, a gamma correction circuit 1012-3, a rendering circuit 1012-4, etc. The data conversion circuit 1012-2 may receive the image data from the controller 1012-1, and may compensate the image data such that the image is displayed at a desired luminance according to the characteristics of the electronic apparatus 1000 or the user's settings or may convert the image data to reduce power consumption or compensate for afterimages. The gamma correction circuit 1012-3 may convert the image data or a gamma reference voltage such that an image displayed on the electronic apparatus 1000 has desired gamma characteristics. The rendering circuit 1012-4 may receive the image data from the controller 1012-1, and may render the image data by considering a pixel arrangement of the display panel 1041 applied to the electronic apparatus 1000. At least one of the data conversion circuit 1012-2, the gamma correction circuit 1012-3, and the rendering circuit 1012-4 may be integrated into another component (e.g., the main processor 1011 or a controller). At least one of the data conversion circuit 1012-2, the gamma correction circuit 1012-3, and the rendering circuit 1012-4 may be integrated into a data driver 1043 to be described below.

The memory 1020 may store various data used by at least one component of the electronic apparatus 1000 (e.g., the processor 1010 or the sensor module 1061) and input data or output data for commands related thereto. The memory 1020 may include at least one of the volatile memory 1021 and the non-volatile memory 1022.

The input module 1030 may receive commands or data to be used in components of the electronic apparatus 1000 (e.g., the processor 1010, the sensor module 1061, or the sound output module 1063) from the outside of the electronic apparatus 1000 (e.g., the user or the external electronic apparatus 1002).

The input module 1030 may include a first input module 1031 through which commands or data are input from the user, and a second input module 1032 through which command or data are input from the external electronic apparatus 1002. The first input module 1031 may include a microphone, a mouse, a keyboard, a key (e.g., button), or a pen (e.g., passive pen or active pen). The second input module 1032 may support a designated protocol that may connect to the external electronic apparatus 1002 by wire or wirelessly. In an embodiment, the second input module 1032 may include a high definition multimedia interface (“HDMI”), a universal serial bus (“USB”) interface, a secure digital (“SD”) card interface, or an audio interface. The second input module 1032 may include a connector that may be physically connected to the external electronic apparatus 1002, e.g., an HDMI connector, a USB connector, an SD card connector, or an audio connector (e.g., a headphone connector).

The display module 1040 may provide visual information to the user. The display module 1040 may include the display panel 1041, a gate driver 1042, and the data driver 1043. The display module 1040 may further include a window, a chassis, and a bracket to protect the display panel 1041. The display module 1040 may correspond to the display device 100 of FIG. 1. The display panel 1041, the gate driver 1042, and the data driver 1043 may correspond to the display panel 110, the gate driver 130, and the data driver 120 of FIG. 1, respectively. The processor 1010 may provide the image data IMD of FIG. 1 and the controller control signal CCS of FIG. 1 to the display module 1040.

The power module 1050 may supply power to components of the electronic apparatus 1000. The power module 1050 may include a battery that charges power voltage. The battery may include a non-rechargeable primary cell, a rechargeable secondary cell, or a fuel cell. The power module 1050 may include a power management circuit 1051. The power management circuit 1051 may supply optimized power to each of the above-described modules and the modules described below. The power module 1050 may include a wireless power transmission/reception member electrically connected to the battery. The wireless power transmission/reception member may include a plurality of coil-shaped antenna radiators.

The electronic apparatus 1000 may further include the internal module 1060 and the external module 1070. The internal module 1060 may include the sensor module 1061, the antenna module 1062, and the sound output module 1063. The external module 1070 may include the camera module 1071, a light module 1072, and a communication module 1073.

The sensor module 1061 may detect an input by the user's body or an input by the pen among the first input module 1031, and may generate an electrical signal or a data value corresponding to the input. The sensor module 1061 may include at least one of a fingerprint sensor 1061-1, an input sensor 1061-2, and a digitizer 1061-3.

The processor 1010 may output commands or data to the display module 1040, the sound output module 1063, the camera module 1071, or the light module 1072 based on the input data received from the input module 1030. In an embodiment, the processor 1010 may generate image data in response to input data applied through the mouse or the active pen and output the image data to the display module 1040, or may generate command data in response to the input data to output the command data to the camera module 1071 or the light module 1072, for example. When no input data is received from the input module 1030 for a predetermined period of time, the processor 1010 may switch an operation mode of the electronic apparatus 1000 to a low-power mode or a sleep mode to reduce power consumption of the electronic apparatus 1000.

The processor 1010 may output commands or data to the display module 1040, the sound output module 1063, the camera module 1071, or the light module 1072 based on sensing data received from the sensor module 1061. In an embodiment, the processor 1010 may compare authentication data authorized by the fingerprint sensor 1061-1 with authentication data stored in the memory 1020, and then may execute an application according to the comparison result, for example. The processor 1010 may execute command or output corresponding image data to the display module 1040 based on sensing data detected by the input sensor 1061-2 or the digitizer 1061-3. When the sensor module 1061 includes a temperature sensor, the processor 1010 may receive temperature data for a temperature measured from the sensor module 1061, and may further perform luminance correction for the image data or the like based on the temperature data.

The display device in the embodiments may be applied to a display device included in a computer, a notebook, a mobile phone, a smart phone, a smart pad, a smart watch, a portable media player (“PMP”), a personal digital assistance (“PDA”), a motion pictures expert group audio layer III (“MP3”) player, or the like.

Although the pixel, the display device, and the electronic apparatus in the embodiments have been described with reference to the drawings, the illustrated embodiments are examples, and may be modified and changed by a person having ordinary knowledge in the relevant technical field without departing from the technical spirit described in the following claims.

What is claimed is:

1. A pixel comprising:
a light-emitting element which emits light based on a driving current, the light-emitting element including:
a first electrode; and
a second electrode which receives a low power voltage having a relatively low power voltage level;
a driving transistor which generates the driving current, the driving transistor including:
a gate connected to a first node;
a first terminal connected to a second node;
a second terminal connected to a third node; and
a body;
a body capacitor which includes:
a first terminal connected to the body of the driving transistor; and
a second terminal; and
a body transistor which includes:
a gate which receives a body gate signal;
a first terminal connected to the second terminal of the body capacitor; and
a second terminal connected to the third node.

2. The pixel of claim 1, further comprising:
a writing transistor which includes a gate which receives a writing gate signal, a first terminal which receives a data voltage, and a second terminal connected to the second node;
a compensation transistor which includes a gate which receives a compensation gate signal, a first terminal connected to the third node, and a second terminal connected to the first node; and
an initialization transistor which includes a gate which receives an initialization gate signal, a first terminal which receives an initialization voltage, and a second terminal connected to the first node.

3. The pixel of claim 2, wherein the body gate signal has an activation level in an initialization period in which the initialization gate signal has an activation level.

4. The pixel of claim 3, wherein a body voltage of the body of the driving transistor is applied to the third node in the initialization period.

5. The pixel of claim 2, wherein the body gate signal has a plurality of pulses in which an activation level and a deactivation level alternate in an initialization period in which the initialization gate signal has an activation level.

6. The pixel of claim 2, wherein the body gate signal has a deactivation level in a writing-compensation period in which each of the writing gate signal and the compensation gate signal has an activation level.

7. The pixel of claim 6, wherein a value obtained by subtracting a threshold voltage of the driving transistor and a body voltage of the body of the driving transistor from the data voltage is applied to the first node in the writing-compensation period.

8. The pixel of claim 2, further comprising:
a first emission transistor which includes a gate which receives an emission signal, a first terminal which receives a high power voltage having a relatively low power voltage level, and a second terminal connected to the second node; and
a second emission transistor which includes a gate which receives the emission signal, a first terminal connected to the third node, and a second terminal connected to the first electrode of the light-emitting element.

9. The pixel of claim 8, wherein the body gate signal has a deactivation level in an emission period in which the emission signal has an activation level.

10. The pixel of claim 8, further comprising:
a bypass transistor which includes a gate which receives a bypass gate signal, a first terminal which receives the initialization voltage, and a second terminal connected to the first electrode of the light-emitting element.

11. The pixel of claim 8, wherein a variable voltage is applied to the body of the driving transistor.

12. The pixel of claim 11, wherein the variable voltage has a voltage level equal to the relatively low power voltage level of the low power voltage in an initialization period in which the initialization gate signal has an activation level, and has a voltage level equal to the relatively high power voltage level of the high power voltage in an emission period in which the emission signal has an activation level.

13. A display device comprising:
a display panel which includes a pixel, the pixel comprising:
a light-emitting element which emits light based on a driving current, the light-emitting element including:
a first electrode; and
a second electrode which receives a low power voltage having a relatively low power voltage level;
a driving transistor which generates the driving current, the driving transistor including:
a gate connected to a first node;
a first terminal connected to a second node;
a second terminal connected to a third node; and
a body;
a body capacitor which includes:
a first terminal connected to the body of the driving transistor; and
a second terminal; and
a body transistor which includes:
a gate which receives a body gate signal;
a first terminal connected to the second terminal of the body capacitor; and
a second terminal connected to the third node; and
a panel driver which provides a data voltage, gate signals including the body gate signal, and an emission signal to the pixel.

14. The display device of claim 13, wherein the pixel further comprises:
a writing transistor which includes a gate which receives a writing gate signal of the gate signals, a first terminal which receives the data voltage, and a second terminal connected to the second node;
a compensation transistor which includes a gate which receives a compensation gate signal of the gate signals, a first terminal connected to the third node, and a second terminal connected to the first node; and
an initialization transistor which includes a gate which receives an initialization gate signal of the gate signals, a first terminal which receives an initialization voltage, and a second terminal connected to the first node.

15. The display device of claim 14, wherein the body gate signal has an activation level in an initialization period in which the initialization gate signal has an activation level.

16. The display device of claim 14, wherein the body gate signal has a deactivation level in a writing-compensation period in which each of the writing gate signal and the compensation gate signal has an activation level.

17. The display device of claim 14, wherein the pixel further comprises:
a first emission transistor which includes a gate which receives the emission signal, a first terminal which receives a high power voltage having a relatively low power voltage level, and a second terminal connected to the second node; and
a second emission transistor which includes a gate which receives the emission signal, a first terminal connected to the third node, and a second terminal connected to the first electrode of the light-emitting element.

18. The display device of claim 17, wherein the body gate signal has a deactivation level in an emission period in which the emission signal has an activation level.

19. The display device of claim 17, wherein the pixel further comprises:
a bypass transistor which includes a gate which receives a bypass gate signal of the gate signals, a first terminal which receives the initialization voltage, and a second terminal connected to the first electrode of the light-emitting element.

20. An electronic apparatus comprising:
a display panel which includes a pixel, the pixel comprising:
a light-emitting element which emits light based on a driving current, the light-emitting element including:
a first electrode; and
a second electrode which receives a low power voltage having a relatively low power voltage level;
a driving transistor which generates the driving current, the driving transistor including:
a gate connected to a first node;
a first terminal connected to a second node;
a second terminal connected to a third node; and
a body;
a body capacitor which includes:
a first terminal connected to the body of the driving transistor; and
a second terminal; and
a body transistor which includes:
a gate which receives a body gate signal;
a first terminal connected to the second terminal of the body capacitor; and
a second terminal connected to the third node;
a panel driver which provides a data voltage, gate signals including the body gate signal, and an emission signal to the pixel; and
a processor which provides image data to the panel driver,
